(19) United States
(12) Patent Application Publication
(10) Pub. No.: US 2026/0309274 A1
(43) Pub. Date: Oct. 8, 2026

(54) SINGLE-LAYER OR MULTILAYER STRUCTURE FOR TRANSPORTING, STORING OR DISTRIBUTING COMPRESSED GAS

(71) Applicant: Arkema France, Puteaux (FR)

(72) Inventors: Arthur BABEAU, Lacq (FR); Axel SALINIER, Lacq (FR); Thibaut SAVART, Lacq (FR); Mathieu CAPELOT, Lacq (FR); Gilles HOCHSTETTER, Colombes Cedex (FR)

(73) Assignee: Arkema France, Puteaux (FR)

(21) Appl. No.: 19/482,430

(22) PCT Filed: May 7, 2024
(86) PCT No.: PCT/EP2024/062638

§ 371 Date: Nov. 7, 2025

(30) Foreign Application Priority Data
May 10, 2023 (FR) FR2304637

(51) Int. Cl. F17C 1/16; B32B 5/26; B32B 37/04

(52) U.S. Cl. CPC F17C 1/16; B32B 5/26; B32B 37/04; B32B 2250/02; B32B 2250/20; B32B 2260/021; B32B 2260/046; B32B 2305/34; B32B 2307/7376; B32B 2377/00; B32B 2439/40; F17C 2203/0663; F17C 2203/0675; F17C 2203/068; F17C 2221/012

(57) ABSTRACT

Embodiments relate to a structure for transporting, storing or distributing compressed gas, preferably under high pressure hydrogen, comprising: at least one composite reinforcing layer constituting the envelope of said structure, consisting of continuous fibers impregnated with a composition predominantly comprising at least one ductile, preferably semicrystalline, thermoplastic polymer, having a glass transition temperature (Tg) less than or equal to the operating temperature To, or said Tg being greater than the operating temperature To with |To−Tg|≤+120° C., in particular |To−Tg|≤+80° C., notably |To−Tg|≤+50° C.; the impregnated fibrous material of which said composite reinforcing layer has a transverse breaking strain greater than the breaking strain of said fibers, at the operating temperature and at the strain rate representative of the use; and said structure not containing an internal sealing layer.

The invention relates to single-layer or multilayer structures for transporting, storing or distributing compressed gas, preferably under high pressure, in particular hydrogen, to the use thereof and to a process for producing same.

### PRIOR ART

Structures for transporting, storing or distributing compressed gas, preferably under high pressure, in particular hydrogen, using a composite reinforcement to ensure pressure resistance, i.e. type Ill or IV tanks, all include a liner (sealing layer) made of metal (type III) or polymer (type IV) to ensure leaktightness to gas, in particular to hydrogen, because the composite layer includes porosities and microcracks that prevent it from being impermeable to gas, in particular to hydrogen.

Type V tanks, i.e. composite tanks without a liner, therefore remain an interesting target today, as they are more economical (no liner to manufacture) and more efficient (higher volumetric storage efficiency), but are currently inaccessible due, notably, to the transverse microcracking of composites which is seen prematurely when pressurized, notably repeatedly, i.e. which appears at a pressure value equal to a fraction of the operating pressure.

Thus, the solution closest to a type V, sometimes called type 4.5, consists in making a monolithic thermoplastic or thermosetting composite tank, in which the composite is welded to the liner. To do this, it may be advantageous to use several layers of composite, one of which includes a matrix having a melting point close to that of the polymer of which the liner is composed, so as to limit residual thermal stresses on the liner.

International patent application WO 2021/019 181 thus describes a multilayer structure chosen from a tank, pipe or tube, intended for transporting, distributing or storing hydrogen, comprising, from the inside outward, at least one sealing layer and at least one composite reinforcing layer.

The European Union has just ratified the end of combustion engines, which will take effect in 2035.

One of the aims pursued is to provide vehicles which are less and less polluting.

Thus, electric or hybrid vehicles comprising a battery aim to gradually replace combustion-engine vehicles, such as gasoline or diesel vehicles. Now, it turns out that the battery is a relatively complex constituent of the vehicle. Depending on the location of the battery in the vehicle, it may be necessary to protect it from impacts and from the external environment, which can be at extreme temperatures and at a variable humidity. It is also necessary to avoid any risk of flames.

In addition, each battery manufacturer designs its batteries according to a specific model, making them unsuitable for widespread use independently of the chosen vehicle model. Thus, each car manufacturer must adapt to the design constraints of the batteries and review its models accordingly to integrate them.

In addition, it is important for its operating temperature not to exceed 55° C. in order not to damage the cells of the battery and to preserve its service life. Conversely, for example in winter, it may be necessary to raise the temperature of the battery so as to optimize its operation.

Moreover, electric vehicles still suffer today from several problems, namely the battery autonomy, the use in these batteries of rare earths, the resources of which are not inexhaustible, and a problem of electricity production in the various countries in order to be able to recharge the batteries.

Hydrogen therefore represents an alternative to electric batteries, since hydrogen can be converted into electricity by means of a fuel cell and thus power electric vehicles. In addition, hydrogen is increasingly under consideration as a fuel that can potentially be used in a conventional combustion engine (known as “zero CO2 emission retrofit”), or even designed specifically to burn hydrogen (in which case the emissions are zero, including NOX).

Nevertheless, the storage of hydrogen is technically difficult and expensive because of its very low molar mass and its very low liquefaction temperature, most particularly when mobile storage is involved. However, in order to be effective, storage must be in a small volume, which makes it necessary to keep the hydrogen under high pressure, taking into account the operating temperatures of the vehicles. This is the case, in particular, with fuel cell hybrid road vehicles for which autonomy of the order of 600 to 700 km is desired, or even less for essentially urban uses complementing a battery electric base.

It is thus necessary to reduce the production costs of compressed gas tanks, notably hydrogen tanks, while at the same time maintaining their gas impermeability properties, particularly with regard to hydrogen, and ensuring that they have sufficient strength to allow repeated use of the tank at the operating (or working) pressure, notably during the pressure cycling inherent in its use.

The present invention thus relates to a single-layer or multilayer structure for transporting, storing or distributing compressed gas, preferably under high pressure, in particular hydrogen, comprising:
at least one composite reinforcing layer constituting the envelope of said structure, consisting of a fibrous material in the form of continuous fibers impregnated with a composition predominantly comprising at least one ductile thermoplastic polymer, which is preferably semicrystalline, having a glass transition temperature (Tg) measured according to the standard ISO 11357-3:2013, said Tg being less than or equal to the operating temperature To, or said Tg being greater than the operating temperature To with |To−Tg|≤+120° C., in particular |To−Tg|≤+80° C., notably |To−Tg|≤+50° C.,
the impregnated fibrous material of which said composite reinforcing layer is composed having, after consolidation, a transverse breaking strain greater than the breaking strain of said fibers, in particular greater than 1.6%, notably 1.8%, in particular 2%, more particularly 2.2%, at the operating temperature and at the strain rate representative of the use,
   said structure not containing an internal sealing layer.

The inventors thus found, unexpectedly, that a structure having at least one composite reinforcing layer whose thermoplastic polymer is ductile and has a Tg as defined above, and whose impregnated fibrous material of which said composite reinforcing layer is composed displays, after consolidation, a transverse breaking strain, as defined above, made it possible to dispense with the presence of an internal sealing layer (liner) while at the same time maintaining its gas impermeability properties, in particular to hydrogen, and having sufficient strength to allow repeated use of the tank at the operating (or working) pressure, notably during the pressure cycling inherent in its use, and thus reducing the production costs of compressed gas tanks, notably hydrogen tanks.

The structure defined above has several advantages, notably:
having greater volumetric storage efficiency than a tank with an internal sealing layer (liner),
offering weight savings and greater mass storage efficiency compared to a tank with an internal sealing layer (liner),
eliminating the risk of collapse (delamination) of the liner (sealing layer), which exists with type IV tanks that have an internal sealing layer that does not adhere to the composite reinforcing layer,
offering economic benefits linked to the elimination of the liner manufacturing and drying steps, and savings in the starting materials used to manufacture the liner,
simplifying tank manufacture by using hot-applied thermoplastic prepregs (or tapes), in particular tapes including a high-performance, high-melting matrix,
facilitating the recycling of the final tank with a single type of material used (carbon fibers impregnated with a thermoplastic polymer),
limiting the number of interfaces and thus the risk of leaks in the tank,
eliminating differential strains (liner vs. composite) during the manufacturing phases and thus reducing internal residual stresses,
having improved fatigue strength (i.e. pressure cycling related to the filling and emptying cycles) of the tank and thus increasing its service life.

The composite reinforcing layer thus consists of at least one stratum which is a consolidated fibrous material.

The term “structure” denotes any hollow three-dimensional structure that can withstand pressure, to the exclusion of any such structure.

The term “structure” refers in particular to a tank, pipe or tube comprising or consisting of one or more layers, in particular a tank.

The structure can be a tank, pipe or tube for the mobile storage of hydrogen, that is to say on a truck for the transportation of hydrogen, on a car for the transportation of hydrogen and the supplying with hydrogen of a fuel cell, for example, on a train for supplying with hydrogen or on a drone for supplying with hydrogen, but it can also be a tank, pipe or tube for the stationary storage of hydrogen at a station for the distribution of hydrogen to vehicles.

The expression “under high pressure” means several hundred bar, in particular from 100 to 900 bar (or 100 000 to 900 000 hPa), in particular from 300 to 900 bar (or 300 000 to 900 000 hPa).

In one embodiment, said structure comprises or consists of a single layer.

In another embodiment, said structure comprises or consists of two layers.

The term “gas” denotes any substance that is in an expandable and compressible fluid state (gaseous state) under conditions of temperature above −253° C. and pressure below 3000 bar.

The term “gas” in particular denotes air, helium, oxygen, nitrogen, methane, natural gas, natural gas for vehicles (NGV) such as compressed natural gas (CNG) or liquefied natural gas (LNG), liquefied petroleum gas (LPG), propane, butane and hydrogen, notably methane, natural gas, natural gas for vehicles (NGV) such as compressed natural gas (CNG) or liquefied natural gas (LNG), liquefied petroleum gas (LPG), propane, butane and hydrogen, particularly hydrogen.

The term “operating temperature To” means the temperature at which the structure is used. Needless to say, this temperature depends on the type of gas being transported (or conveyed), stored or distributed and the type of use. Thus, during rapid filling, said structure (i.e. the tank or pipe) heats up and the To increases as the pressure increases. During rapid emptying, said structure cools and the To reduces as the pressure drops.

The use may be the storage of gas, in particular hydrogen, in a gas refueling station, in particular as regards hydrogen for all types of vehicles, light and heavy fleets, for the mobility, industrial, storage and energy markets.

It may also be the use for transporting hydrogen under the sea to land from an offshore wind turbine on which seawater is electrolyzed to produce green hydrogen, which is then transported onshore to a storage or refueling station.

In one embodiment, the operating temperature To ranges from −80° C. to +160° C. When the structure is in use, the composite reinforcement must be able to withstand the strains of the structure as a function of the temperature and pressure of the compressed gas. The composite reinforcement allows the structure to withstand the internal pressure in said structure generated by the fluid being transported (or conveyed), stored or distributed.

According to Professor Antoine Chateauminois' course at ESCPI (Composite Materials Course, Failure Processes in Unidirectional (UD) Composites, Sheet 3, May 2000), under transverse loading, the failure of a unidirectional ply involves matrix cracking and delamination at the fiber/matrix interface. This failure mode generally corresponds to the first damage observed in cross-laminated composites subjected to tensile forces. Transverse cracks, said to be intralaminar, are then observed in the plies that are disoriented relative to the loading axis. These failures occur well before the failure of the plies oriented at 0° relative to the loading axis. To prevent the appearance of these transverse cracks, said impregnated fibrous material of which said composite reinforcing layer, constituting the envelope of said structure, is composed must therefore display, after consolidation, a transverse breaking strain greater than the breaking strain of said fibers, in particular greater than 1.6%, notably 1.8%, particularly 2%, more particularly 2.2%, at the operating temperature and at the strain rate representative of the use.

In one embodiment, the operating temperature To ranges from −80° C. to +150° C. The behavior of a material, such as its brittleness or its ductility, depends, inter alia, on the strain rate.

In one embodiment, the strain rate representative of the use is from 10⁻⁵ to 10² s⁻¹, in particular from 10⁻⁵ s⁻¹ to 1 s⁻¹, and particularly from 10⁻³ to 1 s⁻¹.

The term “ductile” denotes the ability of a material to deform plastically without breaking.

It has thus been found that if the transverse breaking strain of the composite occurs after the fibers break, then the problem of premature microcracking during use of the tanks no longer exists and the use of a liner can be dispensed with. Doing so is all the more readily accomplished given that it is moreover known that, prior to mechanical stress, a semicrystalline thermoplastic matrix composite can have very low permeability to hydrogen if the composite is well consolidated and has no defects (porosity, microcracks related to the thermal manufacturing cycle, etc.).

The structure thus comprises a composite whose transverse mechanical properties are sufficient to prevent microcracking. This resistance is sufficient to allow repeated use of the tank at the operating pressure because the structure comprises a composite that has good transverse resistance, even during the pressure cycling inherent in its use.

The transverse breaking strain of said composite reinforcing layers obtained is evaluated according to the standard ISO 527-5:2021 on a coupon: a 2 mm thick, 300 ×300 mm plate, made up of a stack of 16 unidirectional UD layers of impregnated fibrous material, is obtained by flat laser deposition followed by autoclave consolidation. Transverse tensile test specimens were machined (T90°) from the plate obtained, with the fiber axis perpendicular to the axis of the test specimen, and then tested at a strain rate of 10⁻⁵ s⁻¹, 10⁻³ s⁻¹, 1 s⁻¹ and 10² s⁻¹ and at temperatures of −60° C., +23° C., and +85° C.

Although the plate tested was manufactured using a different process from the manufacturing process of said structure of the invention, the transverse breaking strain results obtained on this plate ensure the satisfactory behavior of said structure and, notably, the leaktightness of said structure under pressure.

The transverse breaking strain can also be evaluated via other methods, for example:
on a unidirectional composite made up of the same type of fiber and the same polymer matrix, by applying a tension to this composite, perpendicular to the axis of the fibers and, in particular, a breaking strain value greater than that of the fibers used, preferably greater than 1.6%, notably 1.8%, in particular 2%, more particularly 2.2%, at the operating temperature and at the strain rate representative of the use, will be sought.
or on a laminated plate with a 0-90° orientation by applying a tension in one of the two directions and, in particular, the fibers stressed in their longitudinal direction (i.e. in the direction of the strain imposed by the tensile testing machine) must break before those in the transverse plies in the tension direction.
or a laminated plate with a 0-90° orientation, in biaxial bending, consisting in punching the plate in the middle and transversely to its thickness, the plate being previously deposited onto a hollow support, and in particular, in the off-axis directions of the fibers, a radial or orthoradial strain value greater than the breaking strain of the fiber used, preferably greater than 1.6%, notably 1.8%, in particular 2%, and more particularly 2.2%, at the operating temperature and at the strain rate representative of the use, will be sought.
or on a laminated plate with a 0-90° orientation, under biaxial tension, by applying a tension simultaneously in the two directions of the fibers of the plate and, particularly, in the off-axis directions of the fibers, a radial or orthoradial strain value greater than the breaking strain of the fiber used, preferably greater than 1.6%, notably 1.8% in particular 2%, more particularly 2.2%, at the operating temperature and at the strain rate representative of the use, will be sought.
or on a laminated plate with a quasi-iso orientation of 0°/+−45°/90°, by applying a traction in one of the four directions of the fibers of the plate and, in particular, a breaking strain greater than that of the fibers used, preferably greater than 1.6%, notably 1.8%, in particular 2%, more particularly 2.2%, at the operating temperature and at the strain rate representative of the use, will be sought.
or on a quasi-iso laminated plate with an orientation of 0°/+−45°/90°, in biaxial bending, consisting in punching the plate in the middle and transversely to its thickness, the plate being previously deposited onto a hollow support, and in particular, a value of 1.6%, notably 1.8%, in particular 2%, more particularly 2.2%, of radial or orthoradial strain, at the operating temperature and strain rate representative of the use, will then be sought.
or in biaxial tension, on a laminated plate with a quasi-iso orientation of 0°/+−45°/90°, by applying a tension in 2 of the 4 directions of the plate fibers, and in particular, a value of 1.6%, notably 1.8%, in particular 2%, and more particularly 2.2%, of radial or orthoradial strain, at the operating temperature and strain rate representative of the use, will then be sought.

The tensile tests are performed at different temperatures according to the standard ISO 527-1:2012 on type 1BA dumbbells.

The consolidated plates have a pore content of less than 5%, in particular less than 2%.

The pore content may be determined by image analysis.

It may also be determined by calculating the relative difference between the theoretical density and the experimental density (general method):
a) The data required are:
   The density of the thermoplastic matrix
   The density of the fibers
   The basis weight of the reinforcement:
      linear mass (g/m) for example for a ¼ inch tape (derived from a single roving)
      mass per unit area (g/m²), for example for a wider tape or a fabric
b) Measurements to be performed:

The number of samples must be at least 30 in order for the result to be representative of the material studied.

The measurements to be performed are:
The size of the samples collected:
   Length (if the linear mass is known)
   Length and width (if the mass per unit area is known)
The experimental density of the samples taken:
   Measurements of mass in air and in water
Measurement of the content of fibers is determined in accordance with ISO 1172:1999 or by thermogravimetric analysis (TGA) as determined, for example, in the document B. Benzler, Applikationslabor, Mettler Toledo, Giesen, UserCom 1/2001. The carbon fiber content can be determined according to ISO 14127:2008. Determination of the theoretical mass content of fibers:

### a) Determination of the Theoretical Mass Content of Fibers:

$$\% {Mf}_{th} = \frac{{m}_{l} \cdot L}{{Ms}_{air}} \qquad [ Math 1 ]$$

with
m_{I} the linear mass of the tape,
L the length of the sample and
MSₐᵢᵣ the mass of the sample measured in air.

The variation in the mass content of fibers is assumed to be directly linked to a variation in the content of matrix without taking into account the variation in the amount of fibers in the reinforcement.

### b) Determination of the Theoretical Density:

$${d}_{t h} = \frac{1}{\frac{1 - \% {Mf}_{th}}{{d}_{m}} + \frac{\% {Mf}_{th}}{{d}_{f}}} \qquad [ Math 2 ]$$

with dm and df the respective densities of the matrix and of the fibers.

The theoretical density thus calculated is the accessible density if there is no porosity in the samples.

### c) Evaluation of the Porosity:

The porosity is then the relative difference between theoretical density and experimental density.

In one embodiment, the plasticity threshold of the ductile thermoplastic polymer impregnating the fibrous material in the form of continuous fibers is less than 120 MPa, in particular less than 85 MPa, in particular less than 60 MPa, and notably less than 50 MPa.

The plasticity threshold, denoted 00, represents the boundary between the elastic domain and the plastic domain.

When a part is subjected to stress (when it is pulled, compressed, twisted, etc.), it initially undergoes reversible strain (elastic strain), i.e. its dimensions change, but it regains its original shape when the stress is removed. Certain materials, said to be brittle, break in this strain mode if the stress is too high.

For materials said to be ductile, a sufficient increase in stress (i.e. the stress in the material) causes permanent strain; when the stress stops, the part remains deformed (i.e. the stress in the material has reached the material's plasticity threshold and thus the triggering of an irreversible strain process).

The plasticity threshold can be determined by tensile testing on ISO 527-1BA test specimens.

The tensile test consists in pulling on a bar, and allows the one-dimensional stress-strain curve of the material to be extracted, as illustrated in FIG. 1. During a monotonic load increase, the curve can be seen to have two phases: First phase. This is defined by σ<σ0. The relationship between σ and ε is linear. If the loading has not exceeded the stress limit σ0, the removal of the loading will follow the same path:
there is reversibility; this is the definition of elasticity. The behavior relationship is written as:

σ=E·ε
in which E is Young's modulus, identified as the slope of the line.

Second phase. It is characterized by σ>σ0. The material enters the plastic domain. To observe the irreversibility associated with plastic behavior, it is necessary to remove the loading from the test specimen. The removal of the loading is performed from a strain greater than the elastic strain, εₑ=σ/E. At this stage of strain, the value of the stress in the material, σ, may be equal to the initial elastic limit, σ0, and remain constant for any strain greater than εₑ: the material is then said to have perfectly plastic behavior. This is not generally the case in polymers, and when the strain ε exceeds the elastic strain, εₑ, the stress in the material continues to increase beyond σ0 as the total strain at increases, but at a much lower slope than that imposed by the elastic modulus in the elastic strain regime: this is referred to as work hardening, and the slope of the curve linking the stresses to the strain is the tangent modulus Et, whose value is much lower than that of the elastic modulus E. Conversely, during removal of the loading from the material, which occurs when the applied strain is reduced, the decrease in stress follows a straight line with a slope E. Thus, when the stress becomes zero, it is observed that the strain is not: a residual strain is observed, which is the plastic strain. An additive partition of the uniaxial strain into an elastic and a plastic part is thus identified:

$$ε = {ε}_{e} + {ε}_{p}$$

in which εₑ is the elastic strain, which is reversible (recoverable upon removal of the loading), linked to the stress through the law of elasticity (σ=Eεₑ) and where εₚ is the plastic strain, which is irreversible or residual.

In a simple (uniaxial) tensile test, plastic strain produces irreversible elongation of the test specimen. On the stress-strain curve, the elastic part corresponds to the linear (straight) part of the curve, while the plastic domain corresponds to the inflection of this curve. The stress limit between the two domains defines the elastic limit, denoted here as σo (in metals, this is often referred to as Rₑ 0.2%, which is the nominal stress at 0.2% plastic strain, a value very close to the plasticity threshold go, but more readily measurable in practice).

This mechanical analysis, which applies well to metals at T<Tf/2, remains approximate in the case of polymers, which are subject to pronounced effects of temperature and strain rate that reflect the manifestation of viscous phenomena during polymer strain. Thus, the elastic modulus and stress at the plasticity threshold depend on the strain rate and temperature, as does the plastic strain: this is referred to as viscoplastic strain. The strain partition is expressed as follows:

$$ε = {ε}_{e} + {ε}_{v p}$$

and εᵥₚ can be determined exactly as explained for plastic strain above, except that this value must be determined immediately when the stress becomes zero. After a certain period of rest without stress, the polymer may have recovered part of this strain: viscoplastic strain depends on the observation time.

Moreover, the manifestation of these viscous strain phenomena means that the transition from elastic to plastic behavior is gradual and that the stress-strain curve has a curvature in the plasticity threshold domain, which makes it difficult to measure σo in practice. Thus, it is customary to determine σo by the intersection between the elastic modulus and the tangent modulus. As explained above, the effect of strain rate and temperature means that this value depends on the stress conditions of the polymer, and it is precisely this that will determine whether or not transverse cracking occurs in the composite using this polymer as a matrix: when the value of σo becomes too high, due to a reduction in temperature or an increase in strain rate, fracturing occurs preferentially at the fiber-matrix interface rather than in the resin, and the resin cannot deform (visco)plastically. Conversely, when the temperature is sufficiently high or when the strain rate is sufficiently low, the value of the plasticity threshold, σo, becomes low enough for the polymer to be able to deform (visco)plastically, and fracturing occurs in the resin and at high strain levels, typically greater than the fiber breaking strain, or even greater than 1.6%, notably 1.8%, in particular 2%, and more particularly 2.2%.

The breaking strain of said fibers is evaluated by a tensile test on the dry fiber (or on a tuft of dry fibers) (according to the standard ISO 527-1:2012), which allows measurement of its breaking stress, its modulus, and its breaking strain.

The three quantities are linked by the relationship S=E×epsilon (S=breaking stress, E=modulus, epsilon=breaking strain).

In one embodiment, said structure does not contain an external leaktightness layer. The term “external leaktightness layer” means a leaktightness layer located over said composite reinforcing layer.

### As Regards the Excluded Internal Leaktightness Layer

The excluded internal leaktightness layer is any leaktightness layer consisting of a polymer or polymer composition without fiber, regardless of the polymer or polymer composition of which it is made.

### As Regards the Composite Reinforcing Layer and the Thermoplastic Polymer

One or more composite reinforcing layers may be present.

Each of said layers consists of a composition predominantly comprising at least one thermoplastic polymer. The number of layers present is in particular from 1 to 10, in particular from 1 to 5, notably from 1 to 3, and preferentially it is 1.

The term “predominantly” means that said at least one polymer is present in an amount greater than 50% by weight relative to the total weight of the composition. Advantageously, said at least one predominant polymer is present in an amount greater than 60% by weight, notably greater than 70% by weight, in particular greater than 80% by weight, more particularly greater than or equal to 90% by weight, relative to the total weight of the composition.

Said composition impregnating the fibrous material of said reinforcing layer may also comprise impact modifiers and/or additives.

The additives may be chosen from an antioxidant, a heat stabilizer, a UV absorber, a light stabilizer, a lubricant, an inorganic filler, a flame retardant, a nucleating agent, a plasticizer and a dye.

Advantageously, said composition consists of said thermoplastic polymer predominantly, from 0 to 5% by weight of impact modifier, from 0 to 5% by weight of additives, the sum of the constituents of the composition being equal to 100% (based on a minimum of 90% thermoplastic polymer).

Said at least one predominant polymer of each layer can be identical or different.

In one embodiment, a single predominant polymer is present at least in the composite reinforcing layer.

In one embodiment, each reinforcing layer comprises the same type of polymer.

### The Thermoplastic Polymer

The term “thermoplastic” or “thermoplastic polymer” denotes a material that is generally solid at room temperature, which may be semicrystalline or amorphous, which is in particular semicrystalline, and which softens during an increase in temperature, in particular after passing its glass transition temperature (Tg) and flows at higher temperature when it is amorphous, or which may exhibit sharp melting on passing its “melting” point (Tm) when it is semicrystalline, and which becomes solid again during a reduction in temperature below its crystallization temperature Tc (for a semicrystalline material) and below its glass transition temperature (for an amorphous material).

Tg, Tc and Tm are determined by differential scanning calorimetry (DSC) according to the standards 11357-2:2013 and 11357-3:2013, respectively.

The thermoplastic polymer of the composition is ductile: this means that it shows (visco)plastic strain when deformed beyond its elastic strain, εₑ.

The thermoplastic polymer of the composition of at least one of said composite reinforcing layers is such that its Tg is less than or equal to the operating temperature To, or that its Tg is greater than the operating temperature To with |To−Tg|≤+120° C., in particular |To−Tg|≤+80° C., notably |To−Tg|≤+50° C.

In a first variant, the thermoplastic polymer has a Tg less than or equal to the operating temperature To, regardless of the position of said reinforcing layer.

In one embodiment of this first variant, said reinforcing layer consisting of a composition comprising the thermoplastic polymer with a Tg less than or equal to the operating temperature To is the innermost layer in contact with the compressed gas.

In another embodiment of this first variant, said reinforcing layer consisting of a composition comprising the thermoplastic polymer with a Tg less than or equal to the operating temperature To is the outermost reinforcing layer of the structure. In a second variant, the thermoplastic polymer has a Tg greater than the operating temperature To with |To−Tg|≤+120° C., in particular |To−Tg|≤+80° C., notably |To−Tg|≤+50° C.

In one embodiment of this second variant, said reinforcing layer consisting of a composition comprising the thermoplastic polymer with a Tg such that |To−Tg|≤+120° C. is the innermost layer in contact with the compressed gas.

In another embodiment of this second variant, said reinforcing layer consisting of a composition comprising the thermoplastic polymer with a Tg such that |To−Tg|≤+120° C. is the outermost reinforcing layer of the structure.

In a third variant, the thermoplastic polymer has a Tg higher than the operating temperature To with |To−Tg|≤+80° C.

In one embodiment of this third variant, said reinforcing layer consisting of a composition comprising the thermoplastic polymer with a Tg such that |To−Tg|≤+80° C. is the innermost layer in contact with the compressed gas.

In another embodiment of this third variant, said reinforcing layer consisting of a composition comprising the thermoplastic polymer with a Tg such that |To−Tg|≤+80° C. is the outermost reinforcing layer of the structure.

In a fourth variant, the thermoplastic polymer has a Tg higher than the operating temperature To with |To−Tg|≤+50° C.

In one embodiment of this fourth variant, said reinforcing layer consisting of a composition comprising the thermoplastic polymer with a Tg such that |To−Tg|≤+50° C. is the innermost layer in contact with the compressed gas.

In another embodiment of this fourth variant, said reinforcing layer consisting of a composition comprising the thermoplastic polymer with a Tg such that |To−Tg|≤+50° C. is the outermost reinforcing layer of the structure.

In one embodiment of these four variants, all the reinforcing layers consisting of a composition comprising the thermoplastic polymer are identical and thus correspond to both the innermost and outermost reinforcing layers of the structure.

The number-average molecular mass Mn of said thermoplastic polymer is preferably in a range from 10 000 to 40 000 g/mol, preferably from 12 000 to 30 000 g/mol.

The Mn values are determined in particular by the calculation, starting from the content of the terminal functions determined by potentiometric titration in solution.

The Mn masses can also be determined by size exclusion chromatography or by NMR.

As examples of semicrystalline thermoplastic polymers that are suitable for use in the present invention, mention may be made of:
polyamides,
polyamide-polyethers, polyesters,
polyaryl ether ketones (PAEK),
polyether ether ketones (PEEK),
polyether ketone ketones (PEKK),
polyether ketone ether ketone ketones (PEKEKK),
polyimides, in particular polyetherimides (PEI) or polyamide-imides,
polysulfones (PSU), in particular polyarylsulfones, such as polyphenylsulfones (PPSU),
polyethersulfones (PES).

Semicrystalline polymers are more particularly preferred.

In one embodiment, said thermoplastic polymer is a polyamide, in particular a semicrystalline polyamide.

### Polyamide

The nomenclature used to define polyamides is described in the standard ISO 1874-1:2011 “Plastics—Polyamide (PA) molding and extrusion materials—Part 1: Designation”, notably on page 3 (tables 1 and 2), and is well known to those skilled in the art.

The polyamide may be a homopolyamide or a copolyamide or a mixture thereof. Advantageously, the polyamide, in particular semicrystalline polyamide, has a C/N ratio greater than or equal to 5, preferably greater than or equal to 8, in particular greater than or equal to 9, and more particularly greater than or equal to 10.

The C/N ratio means the ratio of the number of carbon atoms to the number of nitrogen atoms in the polyamide.

In the case of a homopolyamide of PA−X·Y type, the number of carbon atoms per nitrogen atom is the mean of the unit X and of the unit Y.

In the case of a copolyamide, the number of carbons per nitrogen atom is calculated according to the same principle. The calculation is performed on a molar pro rata basis for the different amide units.

The polyamide, in particular semicrystalline polyamide, may be aliphatic, cycloaliphatic or semiaromatic.

In a first variant, the polyamide, which is in particular semicrystalline, is an aliphatic polyamide.

Said at least one aliphatic polyamide, which is in particular semicrystalline, may be obtained from the polycondensation of at least one lactam, or from the polycondensation of at least one amino acid, or from the polycondensation of at least one diamine X with at least one dicarboxylic acid Y.

When said at least one aliphatic polyamide, which is in particular semicrystalline, is obtained from the polycondensation of at least one lactam, it may thus comprise a single lactam or several lactams.

When said at least one aliphatic polyamide, which is in particular semicrystalline, is obtained from the polycondensation of at least one lactam, said at least one lactam is chosen from a C6 to C18 lactam, preferentially a C8 to C12 lactam, more preferentially a C10 to C12 lactam.

Advantageously, said at least one aliphatic polyamide, which is in particular semicrystalline, is obtained from the polycondensation of a single lactam and said lactam may be notably chosen from caprolactam, lauryllactam and undecanolactam, advantageously lauryllactam.

When said at least one aliphatic polyamide, which is in particular semicrystalline, is obtained from the polycondensation of at least one amino acid, said at least one amino acid may be chosen from a C6 to C18 amino acid, preferentially a C10 to C18 amino acid, more preferentially a C10 to C12 amino acid.

A C6 to C12 amino acid is notably 6-aminohexanoic acid, 9-aminononanoic acid, 10-aminodecanoic acid, 10-aminoundecanoic acid, 12-aminododecanoic acid and 11-aminoundecanoic acid and also derivatives thereof, notably N-heptyl-11-aminoundecanoic acid.

When said at least one aliphatic polyamide, which is in particular semicrystalline, is obtained from the polycondensation of at least one amino acid, it may comprise a single amino acid or several amino acids.

Advantageously, said aliphatic polyamide, which is in particular semicrystalline, is obtained from the polycondensation of a single amino acid and said amino acid is chosen from 11-aminoundecanoic acid and 12-aminododecanoic acid, advantageously 11-aminoundecanoic acid.

When said at least one aliphatic polyamide, which is in particular semicrystalline, is obtained from the polycondensation of at least one diamine X with at least one diacid Y, then the diamine is C4-C36, preferentially C6-C18, preferentially C6-C12, more preferentially C10-C12, with at least one diacid Y being C4-C36, preferentially C6-C18, preferentially C6-C12, more preferentially C8-C12, and said at least one diamine X is an aliphatic diamine and said at least one diacid Y is an aliphatic diacid. The diamine may be linear or branched. Advantageously, it is linear.

Said at least one C4-C36 diamine X may be chosen in particular from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is C4-C18 and is chosen from 1,4-butanediamine, 1,5-pentanediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is a C10 to C12 diamine, in particular chosen from 1,10-decamethylenediamine, 1,11-undecamethylenediamine and 1,12-dodecamethylenediamine.

Said at least one dicarboxylic acid Y is C4 to C36 and may be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Y is C6-C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is C6-C12 and is chosen from adipic acid, suberic acid, azelaic acid, sebacic acid, undecanedioic acid and dodecanedioic acid.

Advantageously, said at least one dicarboxylic acid Y is C8-C12 and is chosen from suberic acid, azelaic acid, sebacic acid, undecanedioic acid and dodecanedioic acid. In one embodiment, the polyamide, which is in particular semicrystalline, impregnating the continuous fibers of the composite reinforcing layer is a semicrystalline aliphatic polyamide, in particular chosen from PA410, PA 56, PA59, PA510, PA512, PA513, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, preferably PA 6, PA66, PA410, PA510, PA 69, PA610, PA 512, PA612, PA 514, PA614, PA618, PA1010, PA1012, PA1014, PA1018, PA1214, PA1218, PA11 and PA12, more preferably PA 11 or PA12, and a mixture thereof. Advantageously, the aliphatic polyamide, which is in particular semicrystalline, is partially or totally biobased.

In a second variant, the polyamide, which is in particular semicrystalline, is a semiaromatic polyamide.

The term “semiaromatic polyamide” means here a polyamide derived from monomers comprising at least one monomer bearing an aromatic group and at least one aliphatic or cycloaliphatic monomer.

Examples of suitable monomers containing aromatic groups are terephthalic acid (T) and derivatives thereof, isophthalic acid (I) and derivatives thereof, naphthalenedicarboxylic acid (N) and derivatives thereof, C6 to C20 aromatic diamines, arylamines such as p-xylylenediamine (PXD) and m-xylylenediamine (MXD).

Advantageously, suitable monomers containing aromatic groups are terephthalic acid (T), isophthalic acid (I), p-xylylenediamine (PXD) and m-xylylenediamine (MXD), BAC.

The semiaromatic polyamides may be of the XY type, where X is an alkylaromatic diamine (or arylamine) and Y is a dicarboxylic acid chosen from linear or branched aliphatic dicarboxylic acids, or X is a linear or branched aliphatic diamine and Y is chosen from aromatic dicarboxylic acids.

The semiaromatic polyamide, which may be optionally modified with urea units, may also notably be a semiaromatic polyamide of formula X/YAr, as described in EP 1 505 099, notably a semiaromatic polyamide of formula A/XT in which A is chosen from a unit obtained from an amino acid, a unit obtained from a lactam and a unit corresponding to the formula (Ca-diamine). (Cb-diacid), where a represents the number of carbon atoms in the diamine and b represents the number of carbon atoms in the diacid, a and b each being between 4 and 36, advantageously between 9 and 18, the (Ca-diamine) unit being chosen from linear or branched aliphatic diamines, cycloaliphatic diamines and alkylaromatic diamines, and the (Cb-diacid) unit being chosen from linear or branched aliphatic diacids, cycloaliphatic diacids and aromatic diacids; X·T denotes a unit obtained from the polycondensation of a Cx-diamine and terephthalic acid, with x representing the number of carbon atoms in the Cx-diamine, x being between 6 and 36, advantageously between 9 and 18, notably a polyamide of formula A/6T, A/9T, A/10T or A/11T, A being as defined above, in particular a polyamide PA 6/6T, a PA 66/6T, a PA 61/6T, a PA MPMDT/6T, a PA MXDT/6T, a PA PA11/10T, a PA 11/6T/10T, a PA MXDT/10T, a PA MPMDT/10T, a PA BACT/10T, a PA BACT/6T, PA BACT/10T/6T, a PA 11/BACT/10T, PA 11/BACT/6T, a PA 11/MPMDT/10T, and a PA 11/MXDT/10T, and block copolymers, notably polyamide/polyether (PEBA) copolymers.

T corresponds to terephthalic acid, MXD corresponds to m-xylylenediamine, MPMD corresponds to methylpentamethylenediamine and BAC corresponds to bis(aminomethyl)cyclohexane.

In one embodiment of this second variant, the polyamide, which is in particular semicrystalline, impregnating the continuous fibers of the composite reinforcing layer is a semiaromatic polyamide, in particular chosen from PA MPMDT/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and a mixture thereof.

Advantageously, the semiaromatic polyamide, which is in particular semicrystalline, is partially or totally biobased.

### As Regards the Fibrous Material Before and After its Impregnation

Throughout the description, the terms ribbon or strip or strips of fibrous material impregnated with a thermoplastic polymer or tape may be used and denote the same thing.

As regards the fibers constituting said fibrous material, they are, notably, fibers of mineral, organic or plant origin in the form of tufts.

In one embodiment, the number of fibers per tuft is greater than or equal to 24K (i.e., 24 000 fibers per tuft) for carbon fibers, in particular from 24 to 30K.

In another embodiment, the number of fibers per tuft for carbon fibers is greater than 30K, in particular greater than or equal to 50K.

Advantageously, the basis weight for the glass fiber is greater than or equal to 1200 Tex, notably less than or equal to 4800 Tex, in particular from 1200 to 2400 Tex. Among the fibers of mineral origin, mention may be made of carbon fibers, glass fibers, basalt or basalt-based fibers, silica fibers, or silicon carbide fibers, for example. Among the organic fibers, mention may be made of fibers based on thermoplastic or thermosetting polymers, for instance semiaromatic polyamide fibers, aramid fibers or polyolefin fibers. Preferably, they are based on an amorphous thermoplastic polymer and have a glass transition temperature Tg which is greater than the Tg of the constituent thermoplastic polymer or polymer blend of the impregnation matrix when the polymer or blend is amorphous, or which is greater than the Tm of the constituent thermoplastic polymer or polymer blend of the impregnation matrix when the polymer or blend is semicrystalline. Advantageously, they are based on a semicrystalline thermoplastic polymer and have a melting temperature Tm higher than the Tg of the constituent thermoplastic polymer or polymer blend of the impregnation matrix when the latter is amorphous, or higher than the Tm of the constituent thermoplastic polymer or polymer blend of the impregnation matrix when the latter is semicrystalline. Thus, there is no risk of melting for the constituent organic fibers of the fibrous material during impregnation with the thermoplastic matrix of the final composite. Among the plant-based fibers, mention may be made of natural fibers made from flax, hemp, lignin, bamboo, silk, notably spider silk, sisal, and other cellulose-based fibers, in particular viscose.

These plant-based fibers may be used pure, treated or coated with a coating layer to facilitate adhesion and impregnation of the thermoplastic polymer matrix.

They may also be fibers with supporting yarns.

These constituent fibers can be used alone or as mixtures. Thus, organic fibers can be mixed with mineral fibers to be impregnated with thermoplastic polymer and form the impregnated fibrous material.

Organic fiber tufts may have several basis weights. They may also have several geometries.

The fibers are in the form of continuous fibers, which make up 2D fabrics, nonwovens (NCF), braids or tufts of unidirectional (UD) or nonwoven fibers. The fibers constituting the fibrous material can also be in the form of a mixture of these reinforcing fibers of different geometries.

Preferably, the fibrous material is chosen from glass fibers, carbon fibers, basalt fibers, and basalt-based fibers.

Advantageously, it is used in the form of one or more tufts.

In order to improve the physicochemical bonds between the polymer and the fibers, fiber manufacturers use sizing agents whose composition and content may vary. However, as these are generally organic in nature (thermosetting or thermoplastic resin type) and very often formulated for the impregnation of fibers with low-melting polymers or low-Tg thermosetting polymers, sizing agents are often degraded by the impregnation processes, notably during the pre-impregnation steps (melting, passage through a solvent solution, etc.) and/or during the steps of melting of the thermoplastic matrix, notably when it has a high melting point (for a semicrystalline polymer) or a high Tg (for an amorphous or thermosetting polymer). In addition, the chemical compatibility between the matrix polymer and the sizing agent is not always optimal; the resulting binding strength may possibly be modified positively or negatively compared to that observed with an unsized fiber.

Nevertheless, sizing is essential or unavoidable in certain cases. An unsized fiber is difficult to handle. Specifically, sizing not only promotes adhesion of the matrix to the fiber, but also protects and acts as a binder for carbon or glass fibrils, for example, so as to handle them without breaking them.

In impregnated materials, also known as “ready-to-use” materials, the polymer or blend of thermoplastic impregnation polymers is distributed evenly and homogeneously about the fibers. In this type of material, the thermoplastic impregnation polymer or blend of polymers must be distributed as homogeneously as possible within the fibers so as to obtain minimum porosity, i.e. a minimum of voids between the fibers. Specifically, the presence of porosities in this type of material may act as stress concentration points, for example when subjected to mechanical tensile stress, which then form points of initiation of rupture in the impregnated fibrous material and embrittle it mechanically. Homogeneous distribution of the polymer or polymer blend thus improves the mechanical strength and homogeneity of the composite material formed from these impregnated fibrous materials.

In a first embodiment, the fiber content in said impregnated fibrous material is from 30% to 65% by volume, in particular from 45% to 65% by volume, preferably from 50% to 60% by volume, notably from 52% to 60% by volume, and in particular from 53% to 57% by volume.

The fiber content is determined in accordance with ISO 1172:1999 or by thermogravimetric analysis (TGA) as determined, for example, in the document B. Benzler, Applikationslabor, Mettler Toledo, Giesen, UserCom 1/2001.

The carbon fiber content may be determined according to ISO 14127:2008.

In a second embodiment, the fiber content in said impregnated fibrous material is from 30% to 50% by volume, in particular from 30% to 40% by volume.

The impregnation content may be measured by image analysis (notably by using a microscope or camera or digital camera) of a cross-section of the tape, dividing the surface area of the tape impregnated with the polymer by the total surface area of the product (impregnated surface area plus surface area of the pores). In order to obtain a good quality image, it is preferred to coat the tape cut transversely in a standard polishing resin and polish it using a standard protocol allowing the sample to be observed under a microscope at a magnification of at least 6×.

Advantageously, the pore content of said impregnated fibrous material is less than 5%, in particular less than 2%.

It should be noted that a zero pore content is difficult to obtain and that, consequently, the pore content is advantageously greater than 0% but less than the abovementioned contents.

The pore content corresponds to the content of closed pores and can be determined either by electron microscopy or as the relative difference between the theoretical density and the experimental density of said impregnated fibrous material as described above.

In all cases, the pore content is an average content over a significant volume of fibrous materials, i.e. over a volume greater than or equal to that of a 500 m reel of tape with an average width of 12.7 mm (½ inch) and a thickness of 140 μm.

### As Regards the Single-Layer or Multilayer Structure

The structure may be single-layer or multilayer.

### Single-Layer Structure

According to one embodiment, the structure is single-layered and comprises at least one composite reinforcing layer as defined above.

In a first variant, said structure is single-layered and consists of a single composite reinforcing layer as defined above, excluding any other composite or non-composite layer.

Said reinforcing layer may consist of one or more strata.

In one embodiment of this first variant, said single-layer structure is characterized in that the fiber content by volume of said composite reinforcing layer is between 50% and 60% by volume, notably between 53% and 57% by volume.

Advantageously, the operating temperature in this embodiment of this first variant is above room temperature.

In another embodiment of this first variant, said single-layer structure is characterized in that the fiber content by volume of said composite reinforcing layer is between 30% and 50% by volume, in particular between 30% and 40% by volume.

Advantageously, the operating temperature in this embodiment of this first variant is below −252.8° C. at atmospheric pressure.

Advantageously, in this variant and these embodiments, the thermoplastic polymer of the composition impregnating the fibrous material is an aliphatic polyamide, which is in particular semicrystalline, in particular chosen from PA410, PA 56, PA59, PA510, PA512, PA513, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, preferably PA 6, PA66, PA410, PA510, PA 69, PA610, PA 512, PA612, PA 514, PA614, PA618, PA1010, PA1012, PA1014, PA1018, PA1214, PA1218, PA11 and PA12, more preferably PA 11 or PA12, and a mixture thereof.

Advantageously, the fibrous material present in the composite reinforcing layer in the single-layer structure as defined above is chosen from glass fibers, carbon fibers, basalt fibers or basalt-based fibers.

In one embodiment, said single-layer structure defined above includes one or more injection-molded inserts made of a semicrystalline thermoplastic polymer, which is preferably aliphatic.

### Multilayer Structure

In a second variant, said structure is multilayered and comprises at least the following two successive layers, from the inside outward:
at least one composite reinforcing layer as defined above, said composite reinforcing layer being in contact with the compressed gas,
at least one external composite reinforcing layer consisting of a fibrous material in the form of continuous fibers impregnated with a composition predominantly comprising at least one thermoplastic polymer, which is preferably semicrystalline,
   said composite reinforcing layer and said external composite reinforcing layer being different,
   said outermost composite reinforcing layer being welded to the innermost composite reinforcing layer.

The impregnated fibrous material of which said external composite reinforcing layer is composed having, after consolidation, a transverse breaking strain identical to or different from that of the impregnated fibrous material of which said composite reinforcing layer is composed after consolidation.

The thermoplastic polymer of said external composite reinforcing layer is as defined for the composite (and thus internal) reinforcing layer.

Needless to say, the thermoplastic polymer of said composite reinforcing layer and the thermoplastic polymer of said external composite reinforcing layer are different. The term “different” is understood to mean that either the two polymers are of different types, for example one polymer is PEI and the other is chosen from polyaryl ether ketones (PAEK), polyether ether ketones (PEEK) and polyether ketone ketones (PEKK), in particular polyether ether ketones (PEEK), or the two polymers are of the same nature, for example both polymers are polyamides but one is aliphatic and the other is semiaromatic, but these two polymers are compatible, i.e. partially or totally miscible or are able to react together, or the two polymers are two different aliphatic polyamides or two different semiaromatic polyamides, or even the fibrous material is different in nature and/or in the number of fibers in the fibrous material.

Said composition impregnating the fibrous material of said external composite reinforcing layer may also comprise impact modifiers and/or additives.

The additives may be chosen from an antioxidant, a heat stabilizer, a UV absorber, a light stabilizer, a lubricant, an inorganic filler, a flame retardant, a nucleating agent, a plasticizer and a dye.

Advantageously, said composition impregnating the fibrous material of said external composite reinforcing layer consists of said thermoplastic polymer predominantly, 0 to 5% by weight of impact modifier, 0 to 5% by weight of additives, the sum of the constituents of the composition being equal to 100% (based on a minimum of 90% thermoplastic polymer).

Said compositions impregnating the fibrous material of said composite reinforcing layer and the fibrous material of said external composite reinforcing layer are different.

In one embodiment, the thermoplastic polymer impregnating the continuous fibers of the composite reinforcing layer of the multilayer structure defined above is an aliphatic polyamide, in particular chosen from PA410, PA 56, PA59, PA510, PA512, PA513, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, preferably PA 6, PA66, PA410, PA510, PA 69, PA610, PA 512, PA612, PA 514, PA614, PA618, PA1010, PA1012, PA1014, PA1018, PA1214, PA1218, PA11 and PA12, more preferably PA 11 or PA12, and a mixture thereof.

In a first variant of this embodiment, the thermoplastic polymer impregnating the continuous fibers of the external composite reinforcing layer is an aliphatic polyamide, in particular chosen from PA410, PA 56, PA59, PA510, PA512, PA513, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, preferably PA 6, PA66, PA410, PA510, PA 69, PA610, PA 512, PA612, PA 514, PA614, PA618, PA1010, PA1012, PA1014, PA1018, PA1214, PA1218, PA11 and PA12, more preferably PA 11 or PA12, and a mixture thereof, and different from the thermoplastic polymer impregnating the continuous fibers of the composite reinforcing layer.

In a second variant of this embodiment, the thermoplastic polymer impregnating the continuous fibers of the external composite reinforcing layer is a semiaromatic polyamide, in particular chosen from PA MPMDT/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and a mixture thereof.

In another embodiment, the thermoplastic polymer impregnating the continuous fibers of the composite reinforcing layer of said multilayer structure defined above is a semiaromatic polyamide, in particular chosen from PA MPMDT/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and a mixture thereof.

In a first variant of this other embodiment, the thermoplastic polymer impregnating the continuous fibers of the external composite reinforcing layer is an aliphatic polyamide, in particular chosen from PA410, PA 56, PA59, PA510, PA512, PA513, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, preferably PA 6, PA66, PA410, PA510, PA 69, PA610, PA 512, PA612, PA 514, PA614, PA618, PA1010, PA1012, PA1014, PA1018, PA1214, PA1218, PA11 and PA12, more preferably PA11 or PA12, and a mixture thereof, and different from the thermoplastic polymer impregnating the continuous fibers of the composite reinforcing layer.

In a second variant of this other embodiment, the thermoplastic polymer impregnating the continuous fibers of the external composite reinforcing layer is a semiaromatic polyamide, in particular chosen from PA MPMDT/6T, PA11/10T, PA11/BACT, PA5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and a mixture thereof.

In yet another embodiment, in the multilayer structure defined above, the composite reinforcing layer has a thickness of between 1% and 30%, more particularly a thickness of between 1% and 10%, and even more preferably between 1% and 5% relative to the total thickness of the layers of the structure.

In yet another embodiment, in the multilayer structure defined above, the fiber content by volume of the composite reinforcing layer is from 30% to 50%, notably from 30% to 40%.

In yet another embodiment, in the multilayer structure defined above, the fiber content by volume of the external composite reinforcing layer is from 50% to 60%, notably from 53% to 60% by volume, in particular from 53% to 57% by volume.

In yet another embodiment, in the multilayer structure defined above, the fiber content by volume of the composite reinforcing layer is from 30% to 50%, notably from 30% to 40%, and the fiber content by volume of the external composite reinforcing layer is from 50% to 60%, notably from 53% to 60% by volume, in particular from 53% to 57% by volume.

Advantageously, the fibrous material present in the composite reinforcing layer and in the external composite reinforcing layer in the multilayer structure as defined above is chosen from glass fibers, carbon fibers, basalt fibers or basalt-based fibers.

In one embodiment, said multilayer structure defined above comprises one or more injection-molded inserts made of a semicrystalline thermoplastic polymer, which is preferably aliphatic.

In one embodiment, said multilayer structure consists of two layers.

In another embodiment, said multilayer structure further comprises at least one other layer consisting of a composition predominantly comprising at least one thermoplastic polymer, which is preferably semicrystalline, and located over the last external composite reinforcing layer.

Advantageously, said thermoplastic polymer is a polyamide, which is in particular semicrystalline.

In particular, said polyamide is chosen from an aliphatic polyamide and a semiaromatic polyamide.

Advantageously, the fibers of the composite reinforcing layer are of higher strength than the fibers of the external composite reinforcing layer.

In one embodiment, the fibers of the external composite reinforcing layer are fibers greater than 30K.

In another embodiment, the fibers of the composite reinforcing layer are fibers less than or equal to 30K.

In yet another embodiment, the fibers of the external composite reinforcing layer are fibers greater than 30K and the fibers of the composite reinforcing layer are fibers less than or equal to 30K.

In one embodiment, said multilayer structure consists of three layers.

In yet another embodiment, said multilayer structure comprises at least four layers: at least one composite reinforcing layer constituting the envelope of said structure as defined above,
at least one external composite reinforcing layer consisting of a fibrous material in the form of continuous fibers impregnated with a composition predominantly comprising at least one thermoplastic polymer, which is preferably semicrystalline, said composite reinforcing layer and said external composite reinforcing layer being different,
said outermost composite reinforcing layer being welded to the innermost composite reinforcing layer,
at least a second external composite reinforcing layer consisting of a fibrous material in the form of continuous fibers impregnated with a composition predominantly comprising at least one thermoplastic polymer, which is preferably semicrystalline, said composite reinforcing layer and said external composite reinforcing layer being different,
said second external composite reinforcing layer being welded to the first external composite reinforcing layer,
at least a fourth layer consisting of a composition predominantly comprising at least one thermoplastic polymer, which is preferably semicrystalline, and located over the last external layer of the second composite reinforcing layer.

In one embodiment, the fibers of the composite reinforcing layer are fibers less than or equal to 30K.

In another embodiment, the fibers of the first external composite reinforcing layer are fibers less than or equal to 30K.

In yet another embodiment, the fibers of the second external composite reinforcing layer are fibers greater than 30K.

In yet another embodiment, the fibers of the composite reinforcing layer are fibers less than or equal to 30K and the fibers of the first composite reinforcing layer are fibers less than or equal to 30K.

In yet another embodiment, the fibers of the composite reinforcing layer are fibers less than or equal to 30K and the fibers of the second external composite reinforcing layer are fibers greater than 30K.

In yet another embodiment, the fibers of the composite reinforcing layer are fibers less than or equal to 30K, the fibers of the first composite reinforcing layer are fibers less than or equal to 30K, and the fibers of the second external composite reinforcing layer are fibers greater than 30K.

In one embodiment, said multilayer structure consists of four layers.

Advantageously, said thermoplastic polymer of the first layer is a polyamide, which is in particular semicrystalline.

In particular, said polyamide of the first layer is chosen from an aliphatic polyamide and a semiaromatic polyamide, notably an aliphatic polyamide.

Advantageously, said thermoplastic polymer of the second layer is a polyamide, which is in particular semicrystalline.

In particular, said polyamide of the second layer is chosen from an aliphatic polyamide and a semiaromatic polyamide, notably a semiaromatic polyamide.

Advantageously, said thermoplastic polymer of the third layer is a polyamide, which is in particular semicrystalline.

In particular, said polyamide of the third layer is chosen from an aliphatic polyamide and a semiaromatic polyamide, notably a semiaromatic polyamide.

Advantageously, said thermoplastic polymer of the fourth layer is a polyamide, which is in particular semicrystalline.

In particular, said polyamide is chosen from an aliphatic polyamide and a semiaromatic polyamide.

According to another aspect, the present invention relates to a process for manufacturing the single-layer or multilayer structure as defined above, characterized in that it comprises at least one step of selecting a constituent composite reinforcing layer of the envelope of said structure, said composite reinforcing layer consisting of a fibrous material in the form of continuous fibers impregnated with a composition predominantly comprising at least one ductile thermoplastic polymer, which is preferably semicrystalline, the impregnated fibrous material having, after consolidation, a transverse breaking strain greater than the breaking strain of said fibers, in particular greater than 1.6%, notably 1.8%, particularly 2%, more particularly 2.2%, at the operating temperature and at the strain rate representative of the use.

The step of selecting said composite reinforcing layer may comprise the following steps:
selection of a ductile thermoplastic polymer (or thermoplastic polymer resin),
impregnation of a fibrous material with said ductile resin via one of the methods well known to those skilled in the art, to lead to unidirectional (UD) ribbons or strips or tapes,
preparation of the composite reinforcing layer from the above ribbons or strips or tapes,
evaluation of the transverse breaking strain of said composite reinforcing layer obtained,
evaluation of the transverse breaking strain of the fibrous material (or fibers) before impregnation,
selection of said composite reinforcing layer having a transverse strain greater than the breaking strain of said fibers, in particular greater than 1.6%, notably 1.8%, particularly 2%, more particularly 2.2% at the operating temperature and at the strain rate representative of the use.

The selection of a ductile polymer resin may be made by determining the plasticity threshold, which may be performed by tensile testing on ISO 527-1BA test specimens.

The polymer resin, considered as suitable for producing a ductile composite, i.e. a composite having a transverse strain greater than 1.6%, notably 1.8%, in particular 2%, more particularly 2.2%, at the temperature or strain rate representative of the use of said composite, is selected if its plasticity threshold is less than 120 MPa, in particular less than 85 MPa, in particular less than 60 MPa, notably less than 50 MPa at the temperature or strain rate representative of the use of said composite.

The composite reinforcing layer can be prepared notably by filament winding, using unidirectional (UD) tapes deposited in successive layers on a mandrel that may be heated, with one or more angles of orientation relative to the axis of the mandrel. The evaluation of the transverse breaking strain of said composite reinforcing layer obtained is performed as described above.

The evaluation of the transverse breaking strain of the fibrous material (or fibers) before impregnation is performed as described above.

Said composite reinforcing layer having a transverse breaking strain greater than the breaking strain of said fibers, in particular greater than 1.6%, notably 1.8%, particularly 2%, more particularly 2.2%, at the operating temperature and at the strain speed representative of the use, is then selected.

In one embodiment, said process comprises, after said selection step, a step of filament winding of said impregnated fibrous material.

In another embodiment, said process comprises, after the filament winding step, a step of welding the external composite reinforcing layer, as defined above, onto said composite reinforcing layer.

The external reinforcing layer is wound onto the outermost layer of the composite reinforcing layer and is welded thereto by heating using a heating system as described in international patent application WO 22/167 757.

According to another aspect, the present invention relates to the use of at least one composite reinforcing layer consisting of a fibrous material in the form of continuous fibers impregnated with a composition predominantly comprising at least one thermoplastic polymer, which is preferably semicrystalline, having a glass transition temperature (Tg) measured according to the standard ISO 11357-3:2013, said Tg being less than or equal to the operating temperature To, or said Tg being greater than the operating temperature To with |To−Tg|≤+120° C., in particular |To−Tg|≤+80° C., notably |To−Tg|≤+50° C.,
said composite reinforcing layer having, after consolidation, a transverse breaking strain greater than the breaking strain of said fibers, in particular greater than 1.6%, notably 1.8%, in particular 2%, more particularly 2.2% at the operating temperature and at the strain rate representative of the use, as defined above,
to constitute the envelope of a single-layer or multilayer structure for transporting, storing or distributing compressed gas, preferably under high pressure, in particular hydrogen.

According to yet another aspect, the present invention relates to the use of the single-layer or multilayer structure, as defined above, for transporting, storing or distributing compressed gas, preferably under high pressure, in particular hydrogen.

### DESCRIPTION OF THE FIGURE

FIG. 1 shows the tensile curve obtained on a polyamide 11, this test being interrupted in the plastic domain: the method for determining the elastic strain εₑ and the plastic strain εₚ and also the plasticity threshold is illustrated.

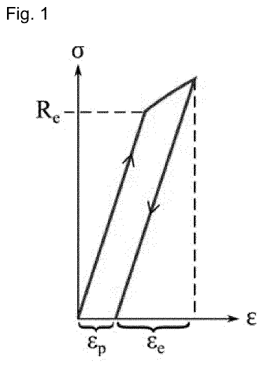

### EXAMPLES

In all the examples, the carbon fiber content by volume is determined by image analysis (notably using a microscope, camera or digital camera) of a cross-section of the tape, dividing the surface area of the tape impregnated with the polymer by the total surface area of the product (impregnated surface area plus surface area of the pores). In order to obtain a good quality image, it is preferred to coat the tape cut transversely in a standard polishing resin and polish it using a standard protocol allowing the sample to be observed under a microscope at a magnification of at least 6×.

### Selection of the Ductile Matrix

Several resin compositions (PA 11/BACT/10T and PA11) were synthesized by polycondensation and then injected according to techniques well known to those skilled in the art to make ISO 527-1BA tensile test specimens.

A ductile polymer resin was selected by determining the plasticity threshold, which was determined by tensile testing on these test pieces. The polymer resin affording a ductile composite was selected when its plasticity threshold was less than 85 MPa at the temperature and strain rate representative of the use.

Selected compositions: PA 11/BACT/10T (Tg 140° C. measured by DSC according to the standard ISO 11357-3:2013) with a plasticity threshold below 85 MPa, which is the case when the operating temperature is ≥85° C. and when the strain rate representative of the selected use is 10⁻³ s⁻¹.

PA11 (Tg 50° C. measured by DSC according to the standard ISO 11357-3:2013) having a plasticity threshold below 85 MPa, which is the case when the operating temperature is ≥−60° C. and when the strain rate representative of the selected use is 10⁻³ s⁻¹.

Composite reinforcing layers were then prepared, after selecting the ductile matrix, from a fibrous material previously impregnated with thermoplastic resin (tape) according to WO 2018/234 436 (according to modified Example 2: strip of fibrous material (or tape) with Hyosung H2550 carbon fiber impregnated with PA 11/BACT/10T (Arkema) or PA11 (Arkema)).

BAC corresponds to bis(aminomethyl)cyclohexane and T corresponds to terephthalic acid.

The composite reinforcing layers were prepared by applying the tape prepared above by filament winding using a robot including a 1500 W infrared heater at a speed of 12 m/min on a mandrel.

The transverse breaking strain of said composite reinforcing layers obtained is evaluated on a coupon: a 2 mm thick, 300×300 mm plate, made up of a stack of 16 unidirectional (UD) layers of impregnated fibrous material, is obtained by flat laser deposition followed by autoclave consolidation. Transverse tensile test specimens were machined) (T90° from the plate obtained, with the fiber axis perpendicular to the axis of the test specimen, and then tested at a strain rate of 10⁻³ s⁻¹ and at temperatures of −60° C., +23° C. and +85° C.

Said composite reinforcing layer having a transverse breaking strain greater than the breaking strain of said fibers, in particular greater than 1.6%, notably 1.8%, particularly 2%, more particularly 2.2%, at the operating temperature and at the strain speed representative of the use, is then selected.

Following these laboratory tests on coupons, the various composite solutions for manufacturing the tank were chosen:

PA 11 composite with a fiber content of 55% by volume was selected to manufacture a tank that will be used at operating temperatures To1=+23° C. and To2=+85° C.

PA 11 composite with a fiber content of 45% by volume was selected to manufacture a tank that will be used at an operating temperature To3=−60° C.

The 11/BACT/10T composite with a fiber content of 40% by volume was selected to manufacture a tank that will be used at an operating temperature To2=+85° C. The following tanks were then prepared by filament winding on a mandrel:

### Example 1: Monolithic Composite Tank, Obtained by Stacking a Single Type of Composite Layer with a Ductile PA11 Matrix and a Carbon Fiber Content of 55% by Volume

The tank is used at an operating temperature To1=23° C. =room temperature (RT), |To1−Tg|=27° C. <50° C.

The tank is also used at To2=85° C. >Tg (50° C.).

A tank of this type is tested under increasing pressure at each of the selected operating temperatures. In both cases, no leaks are detected before the burst pressure is reached.

### Example 2: Monolithic Composite Tank, with a Single Layer of Ductile PA11 Matrix Composite and a Carbon Fiber Content of 45% by Volume, the Tank being Used at an Operating Temperature To3=−60° C. With |To3−Tg|=110° C. <120° C.

It is also used at an operating temperature To >−60° C. and in this case, as a function of the value of this temperature, |To−Tg|≤120° C. or ≤80° C. or ≤50° C. or To >Tg. A tank of this type is tested under increasing pressure at each of the selected operating temperatures. In all cases, no leaks are detected before the burst pressure is reached.

### Example 3

Monolithic composite tank consisting of two layers, a composite reinforcing layer (11/BACT/10T) with a low fiber content (40% by volume) to prevent microcracks, and an external composite reinforcing layer (11/BACT/10T) with a high fiber content to achieve the mechanical properties (55% by volume).

The tank is used at the operating temperature To2=+85° C., with |To2−Tg|=55° C. <80° C.

It is also used at an operating temperature To >+85° C. and in this case, as a function of the value of this temperature, |To−Tg|≤80° C. or ≤50° C. or To >Tg.

A tank of this type is tested under increasing pressure at each of the selected operating temperatures. In all cases, no leaks are detected before the burst pressure is reached.

### Example 4

Monolithic composite tank consisting of two layers, an internal composite reinforcing layer (PA11) with a low fiber content (45% by volume) to prevent microcracks, and an external composite reinforcing layer (PA11/BACT/10T) with a high fiber content to achieve the mechanical properties (55% by volume).

The tank is used at an operating temperature To3=−60° C., with |To3−Tg|=110° C. <120° C., the Tg to be considered being that of the matrix of the composite making up the internal layer of the tank.

The tank is also used at an operating temperature To >−60° C. and in this case, as a function of the value of this temperature, |To−Tg|≤120° C. or ≤80° C. or ≤50° C. or To >Tg, the Tg to be considered being that of the matrix of the composite making up the internal layer of the tank.

A tank of this type is tested under increasing pressure at each of the selected operating temperatures. In all cases, no leaks are detected before the burst pressure is reached.

Determination of the presence of microcracks for the tanks of Examples 1 to 4. The presence of microcracks was determined by detecting a leak before the operating pressure was reached or while the operating pressure was being maintained, according to the following protocol:

Detection of any leaks by means of an underwater pressure test when pressurizing the tank to the operating pressure and/or while maintaining the pressure at the operating pressure.

None of the tanks prepared have any leaks and thus no microcracks.

1. A single-layer or multilayer structure for transporting, storing or distributing compressed gas, comprising:
at least one composite reinforcing layer constituting the envelope of said structure, consisting of a fibrous material in the form of continuous fibers impregnated with a composition predominantly comprising at least one ductile thermoplastic polymer having a glass transition temperature (Tg) measured according to the standard ISO 11357-3:2013, said Tg being less than or equal to the operating temperature To, or said Tg being greater than the operating temperature To with |To−Tg|≤+120° C.,
the impregnated fibrous material of which said composite reinforcing layer is composed having, after consolidation, a transverse breaking strain greater than the breaking strain of said fibers at the operating temperature and at the strain rate representative of the use,
said structure not containing an internal sealing layer.

2. The single-layer or multilayer structure as claimed in claim 1, wherein said thermoplastic polymer of the composite reinforcing layer is a polyamide, which is in particular semicrystalline, having a C/N ratio greater than or equal to 5.

3. The single-layer or multilayer structure as claimed in claim 2, wherein the polyamide impregnating the continuous fibers of the composite reinforcing layer is an aliphatic polyamide, selected from the group consisting of PA410, PA 56, PA59, PA510, PA512, PA513, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, and a mixture thereof.

4. The single-layer or multilayer structure as claimed in claim 2, wherein the polyamide impregnating the continuous fibers of the composite reinforcing layer is a semiaromatic polyamide elected from the group consisting of PA MPMDT/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and a mixture thereof.

5. The single-layer or multilayer structure as claimed in claim 1, wherein it is single-layered and comprises at least one composite reinforcing layer.

6. The single-layer structure as claimed in claim 5, wherein the fiber content by volume of said at least one composite reinforcing layer is from 30% to 50% by volume.

7. The single-layer or multilayer structure as claimed in claim 1, wherein it is multilayered and comprises at least the following two successive layers, from the inside outward:
at least one composite reinforcing layer, said composite reinforcing layer being in contact with the compressed gas,
at least one external composite reinforcing layer consisting of a fibrous material in the form of continuous fibers impregnated with a composition predominantly comprising at least one thermoplastic polymer,
said composite reinforcing layer and said external composite reinforcing layer being different,
said outermost composite reinforcing layer being welded to the innermost composite reinforcing layer.

8. The multilayer structure as claimed in claim 7, wherein the thermoplastic polymer impregnating the continuous fibers of the composite reinforcing layer is an aliphatic polyamide selected from the group consisting of PA410, PA 66, PA59, PA510, PA512, PA513, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, and a mixture thereof.

9. The multilayer structure as claimed in claim 8, wherein the thermoplastic polymer impregnating the continuous fibers of the external reinforcing layer is an aliphatic polyamide selected from the group consisting PA410, PA 56, PA59, PA510, PA512, PA613, PA514, PA6, PA 66, PA 69, PA610, PA612, PA614, PA618, PA1010, PA1012, PApip10, PApip12, PA1014, PA1018, PA1210, PA1212, PA1214, PA1218, PA11, PA12, and a mixture thereof and different from the thermoplastic polymer impregnating the continuous fibers of the composite reinforcing layer.

10. The multilayer structure as claimed in claim 8, wherein the thermoplastic polymer impregnating the continuous fibers of the external composite reinforcing layer is a semiaromatic polyamide, selected from the group consisting of PA MPMDT/6T, PA 11/10T, PA 11/BACT, PA 5T/10T, PA 11/6T/10T, PA MXDT/4T, PA MXDT/6T, PA MXDT/10T, PA MPMDT/4T PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/AT, PA 11/MPMDT/6T, PA 11/MPMDT/10T, PA 11/MXDT/10T, PA 11/5T/10T, and a mixture thereof.

11. The multilayer structure as claimed in claim 7, wherein the thermoplastic polymer impregnating the continuous fibers of the composite reinforcing layer is a semiaromatic polyamide selected from the group consisting of PA MPMDT/6T, PA 11/10T, PA 11/BACT, PA 5T/10T, PA 11/6T/10T, PA MXDT/4T, PA MXDT/6T, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/GT, PA 11/MXDT/10T, PA 11/MPMDT/4T, PA 11/MPMDT/6T, PA 11/MPMDT/10T, PA 11/MXDT/10T, PA11/5T/10T, and a mixture thereof.

12. The multilayer structure as claimed in claim 11, wherein the thermoplastic polymer impregnating the continuous fibers of the external composite reinforcing layer is an aliphatic polyamide selected from group consisting of PA410, PA 56, PA59, PA510, PA612, PA513, PA514 PA6, PA 66, PA 69, PA610, PA612, PA614, PA618, PA1010, PA1012, PApip10, PApip12, PA1014, PA1018, PA1210, PA1212, PA1214, PA1218, PA11, PA12, preferably PA 6, PA66, PA410, PA510, PA 69, PA610, PA 512, PA612, PA 514, PA614, PA618, PA1010, PA1012, PA1014, PA1018, PA1214, PA1218, PA11 and PA12, more preferably PA 11 or PA12, and a mixture thereof.

13. The multilayer structure as claimed in claim 11, wherein the thermoplastic polymer impregnating the continuous fibers of the external composite reinforcing layer is a semiaromatic polyamide selected from the group consisting of PA MPMDT/6T, PA 11/10T, PA 11/BACT, PA 5T/10T, PA 11/6T/10T, PA MXDT/4T, PA MXDT/ST, PA MXDT/10T, PA MPMDT/4T, PA MPMDT/6T, PA MPMDT/10T, PA BACT/10T, PA BACT/6T, PA BACT/4T, PA BACT/10T/6T, PA 11/BACT/4T, PA 11/BACT/6T, PA 11/BACT/10T, PA 11/MXDT/4T, PA 11/MXDT/6T, PA 11/MXDT/10T, PA 11/MPMDT/4T, PA 11/MPMDT/6T, PA 11/MPMDT/10T, PA 11/MXDT/10T, PA11/5T/10T, and a mixture thereof.

14. The multilayer structure as claimed in claim 7, wherein the composite reinforcing layer has a thickness of between 1% and 30% relative to the total thickness of the layers of the structure.

15. The single-layer or multilayer structure as claimed in claim 1, wherein it includes one or more injection-molded inserts made of semicrystalline thermoplastic polymer.

16. A process for manufacturing the single-layer or multilayer structure as defined in claim 1, wherein it comprises at least one step of selecting a constituent composite reinforcing layer of the envelope of said structure, said composite reinforcing layer consisting of a fibrous material in the form of continuous fibers impregnated with a composition predominantly comprising at least one ductile thermoplastic polymer, the impregnated fibrous material having, after consolidation, a transverse breaking strain greater than the breaking strain of said fibers, at the operating temperature and at the strain rate representative of the use.

17. The process as claimed in claim 16, wherein it comprises, after said selection step, a step of filament winding of said fibrous material.

18. The process as claimed in claim 17, wherein it comprises, after the filament winding step, a step of welding the external composite reinforcing layer, wherein the reinforcing layer is single-layered onto said composite reinforcing layer.

19. A method for transporting, storing, or distributing compressed gas, comprising:
preparing an envelope of a structure from at least one composite reinforcing layer consisting of a fibrous material in the form of continuous fibers impregnated with a composition comprising at least one ductile thermoplastic polymer, having a glass transition temperature (Tg) measured according to the standard ISO 11357-3:2013, said Tg being less than or equal to the operating temperature To, or said Tg being greater than the operating temperature To with |To−Tg|≤+120° C.,
said composite reinforcing layer having, after consolidation, a transverse breaking strain greater than the breaking strain of said fibers at the operating temperature and at the strain rate representative of the use,
to constitute the envelope of a structure for transporting, storing or distributing compressed gas;
inserting compressed gas into the envelope; and
transporting, storing, or distributing the compressed gas.

20. The method of claim 19, wherein the compressed gas is hydrogen.
